(19) United States
(12) Patent Application Publication
(10) Pub. No.: US 2017/0169830 A1
(43) Pub. Date: Jun. 15, 2017

(54) METHOD AND APPARATUS FOR INSERTING DATA TO AUDIO SIGNAL OR EXTRACTING DATA FROM AUDIO SIGNAL BASED ON TIME DOMAIN

(71) Applicant: Electronics and Telecommunications Research Institute, Daejeon (KR)

(72) Inventors: Seung Kwon BEACK, Daejeon (KR); Yong Ju LEE, Daejeon (KR); Tae Jin PARK, Daejeon (KR); Jong Mo SUNG, Daejeon (KR); Tae Jin LEE, Daejeon (KR); Jin Soo CHOI, Daejeon (KR)

(73) Assignee: Electronics and Telecommunications Research Institute, Daejeon (KR)

(21) Appl. No.: 15/342,985

(22) Filed: Nov. 3, 2016

(30) Foreign Application Priority Data
Dec. 11, 2015 (KR) 10-2015-0177438

(51) Int. Cl. G10L 19/018; G10L 19/26

(52) U.S. Cl. CPC G10L 19/018; G10L 19/26

(57) ABSTRACT

Disclosed is a method and an apparatus for embedding data in an audio signal based on a time domain, and a method and an apparatus for extracting data from an audio signal based on a time domain. The method for embedding data in an audio signal based on a time domain may include generating a time-domain insertion sequence from original data based on a weighting element, embedding the insertion sequence in a host audio signal, and transmitting the host audio signal in which the insertion sequence is embedded. The method for extracting data from an audio signal based on a time domain may include receiving a time-domain audio signal in which data is embedded, extracting a codeword from the audio signal, and synchronizing the audio signal based on the codeword.

### CROSS-REFERENCE TO RELATED APPLICATION(S)

This application claims the priority benefit of Korean Patent Application No. 10-2015-0177438 filed on Dec. 11, 2015, in the Korean Intellectual Property Office, the disclosure of which is incorporated herein by reference for all purposes.

### BACKGROUND

1. Field

One or more example embodiments relate to an apparatus and a method for hiding or extracting data, and more particularly, to an apparatus and a method for hiding or extracting data in or from an audio signal.

2. Description of Related Art

Audio watermarking refers to technology for adding a distortion or a signal to an audio signal and embedding required auxiliary information, and for extracting the embedded auxiliary information. The auxiliary information embedded in the audio signal may be used to ensure a quality of the audio signal with only a minimum loss, and to determine a copyright on the original audio signal. Due to a recent propagation of portable smart devices or terminals, the audio watermarking has emerged as a method of hiding information and transmitting the hidden information, in addition to a method of determining a copyright.

Although a data transmission rate changes depending on a type of a media application, an audio signal transmission rate may be relatively lower than a wireless communication rate. A transmission environment of an audio channel may be unfavorable compared to a transmission environment of wireless communications, because an audio signal proceeds slowly in the air. For example, a greater reverberation time, or a channel impulse response, may degrade a structure of a frequency and a phase offset in a host audio signal, and may also invite a distortion by an intersymbol interference (ISI). Data including auxiliary information to be extracted may have a greater bit error compared to initially embedded data due to reverberation or noise that is present in an audio channel.

Despite an audio channel distortion that may be experienced by an audio signal, auxiliary information may need to be accurately extracted using the method of hiding data in the audio signal and transmitting the audio signal in which the data is hidden. Such embedded auxiliary information may need to be robust against the audio channel distortion. In addition, a size of the data to be embedded may need to be larger to be used for transmission of various pieces of data. The various pieces of data may be, for example, channel information, time information, or uniform resource locator (URL) information of a site. When information of dozens of bytes is transmitted within a present period of time, a terminal may extract text information from a received audio signal.

As in a case of the wireless communications, a multi-carrier approach may be useful for a distortion using a multipath audio channel, and thus most of acoustic data transmission (ADT) systems are developed based on a frequency domain approach. Similar to a wireless communication domain, the frequency domain approach may maintain a higher data transmission rate, while being robust against a distortion of an audio channel such as reverberation and additive noise, and thus may be useful for embedding data in a host audio signal and modulating the host audio signal in which the data is embedded.

However, when applying a frequency domain to audio channel transmission, an issue may occur. That is, in the frequency domain approach using a spread spectrum, an issue may occur in synchronization when a transmitted data frame is shifted in a time domain. Such an issue may be resolved by adopting sample-based exhaustive search or double transfer for the synchronization. However, the sample-based exhaustive search may require a large amount of power for calculation, and the double-embedded data transfer may degrade a quality of a host audio signal.

### SUMMARY

An aspect provides a method and an apparatus for generating a time-domain insertion sequence from original data based on a weighting element, and embedding or extracting data that may not be heard by or revealed to a third user.

Another aspect also provides a method and an apparatus for embedding or extracting data, which may be robust against a distortion of an audio channel, by filtering a result of a multiplication of a random time sequence and a weighted time-domain carrier signal.

Still another aspect also provides a method and an apparatus for embedding or extracting data, which may be robust against a distortion that may occur in an audio channel, by transmitting the data using a time domain sequence that is selectively modeled in a frequency domain when embedding the data in an audio signal.

According to an aspect, there is provided a method of embedding data in an audio signal, the method including generating a time-domain insertion sequence from original data based on a weighting element, embedding the insertion sequence in a host audio signal, and transmitting the host audio signal in which the insertion sequence is embedded.

The generating of the insertion sequence may include generating a random time sequence from the original data, generating a weighted time-domain carrier signal from the host audio signal, and multiplying the generated random time sequence and the generated weighted time-domain carrier signal.

The generating of the insertion sequence may further include filtering the multiplied carrier signal.

The generating of the random time sequence may include encoding the original data, matching a frame index to the encoded data, and converting the data to which the frame index is matched to time-domain data and generating the random time sequence.

The generating of the weighted carrier signal may include generating a carrier signal by combining the host audio signal and a noisy signal, generating a weighting vector from the host audio signal, and weighting the carrier signal based on the weighting vector.

The generating of the weighted carrier signal may further include converting the weighted carrier signal to a time-domain signal.

The generating of the carrier signal by combining the host audio signal and the noisy signal may include multiplying a window and a result obtained by combining the host audio signal and the noisy signal.

The embedding may include converting the host audio signal to a frame unit.

The transmitting may include sampling the host audio signal in which the insertion sequence is embedded, and transmitting the sampled audio signal.

According to another aspect, there is provided a method of extracting data from an audio signal, the method including receiving a time-domain audio signal in which data is embedded, extracting a codeword from the received audio signal, and synchronizing the audio signal based on the extracted codeword.

The receiving may include converting the received audio signal to a frame unit.

The extracting of the codeword may include determining a correlation between the audio signal and a random time sequence, and extracting the codeword from the correlation.

The audio signal in which the data is embedded may be associated with the random time sequence.

The extracting of the codeword may include extracting an offset from the correlation between the audio signal and the random time sequence. The synchronizing may include synchronizing the audio signal based on the extracted offset.

The method may further include decoding the codeword.

According to still another aspect, there is provided an apparatus for embedding data in an audio signal, the apparatus including an insertion sequence generator configured to generate a time-domain insertion sequence from original data based on a weighting element, an inserter configured to embed the insertion sequence in a host audio signal, and a transmitter configured to transmit the host audio signal in which the insertion sequence is embedded.

According to yet another aspect, there is provided an apparatus for extracting data from an audio signal, the apparatus including an audio receiver configured to receive a time-domain audio signal in which data is embedded, a codeword extractor configured to extract a codeword from the audio signal, and a synchronizer configured to synchronize the audio signal based on the extracted codeword.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating a process of embedding data in an audio signal and transmitting the audio signal embedded with the data, and extracting the embedded data from a received signal according to an example embodiment;

FIG. 2 is a diagram illustrating a process of embedding data in an audio signal in an acoustic data transmission (ADT) encoder according to an example embodiment;

FIG. 3 is a diagram illustrating a process of extracting data from an audio signal in an ADT decoder according to an example embodiment;

FIG. 4 is a flowchart illustrating a method of extracting data from an audio signal based on a time domain according to an example embodiment;

FIG. 5 is a flowchart illustrating a process of generating an insertion sequence from original data according to an example embodiment;

FIG. 6 is a flowchart illustrating a process of generating a random time sequence according to an example embodiment;

FIG. 7 is a flowchart illustrating a process of generating a weighted carrier signal according to an example embodiment;

FIG. 8 is a flowchart illustrating a process of transmitting a host audio signal in which an insertion sequence is embedded according to an example embodiment;

FIG. 9 is a flowchart illustrating a method of extracting data from an audio signal based on a time domain according to an example embodiment;

FIG. 10 is a flowchart illustrating a process of extracting a codeword according to an example embodiment;

FIG. 11 is a diagram illustrating an ADT encoder according to an example embodiment;

FIG. 12 is a diagram illustrating an ADT decoder according to an example embodiment;

FIG. 13 is a graph illustrating an average bit error rate (BER) with respect to different window overlap sizes according to an example embodiment;

FIG. 14 is a graph illustrating an average BER with respect to different frame sizes according to an example embodiment; and

FIG. 15 is a graph illustrating an average BER with respect to different reverberation times according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure. Reference throughout this disclosure to “example embodiment(s)” (or the like) means that a particular feature, constituent or agent, step or characteristic described in connection with the embodiment is included in at least one embodiment. Thus, appearances of the phrases “according to example embodiments” or “an embodiment” (or the like) in various places throughout the disclosure are not necessarily all referring to the same example embodiment.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component.

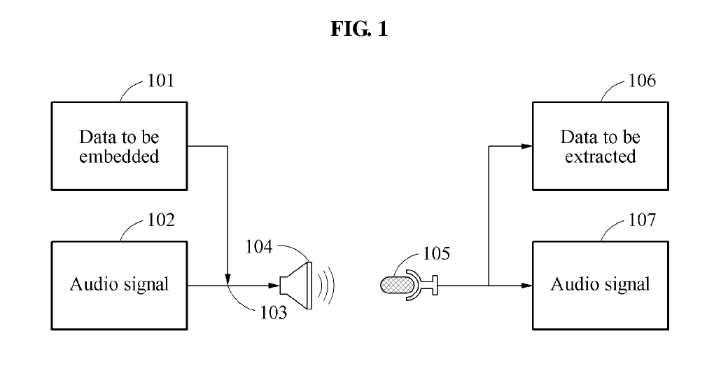

FIG. 1 is a diagram illustrating a process of embedding data in an audio signal and transmitting the audio signal embedded with the data, and extracting the embedded data from a received signal according to an example embodiment. The term “embedding” may be used interchangeably with “inserting” or “insertion” and “adding” or “addition” herein, and “a signal embedded with data” means a signal in which data is embedded.

Acoustic data transmission (ADT) may be a method of connecting a speaker 104 of a transmitter to a microphone 105 of a receiver through a communication channel to improve mobile services. The ADT may be a series of process of embedding auxiliary information 101 in an audio signal 102 to be played by the speaker 104 of the transmitter, for example, a host audio signal, and transmitting the audio signal 102 embedded with the auxiliary information 101, and receiving the transmitted audio signal by the microphone 105 of the receiver and extracting auxiliary information 106 from the received audio signal, for example, an audio signal 107. The ADT may be generally used for audio watermarking for embedding auxiliary information in an audio signal, and may also be expanded to technology for applying communication architecture, such as, for example, modulation, channel coding, and synchronization, and overcoming various distortions that may occur during data transmission.

In an example, a time-domain approach that involves embedding a long random time sequence may be provided. The time-domain approach may also be referred to as time-domain watermarking. The time-domain watermarking may revive an encoding and decoding process of a legacy audio codec. In addition, in the time-domain watermarking, a time-domain random time sequence that is normally embedded in an audio signal may be used for data extraction and time synchronization. The time-domain random time sequence may be used to analyze a correlation between the random time sequence and the audio signal, provide time synchronization information, and extract embedded data.

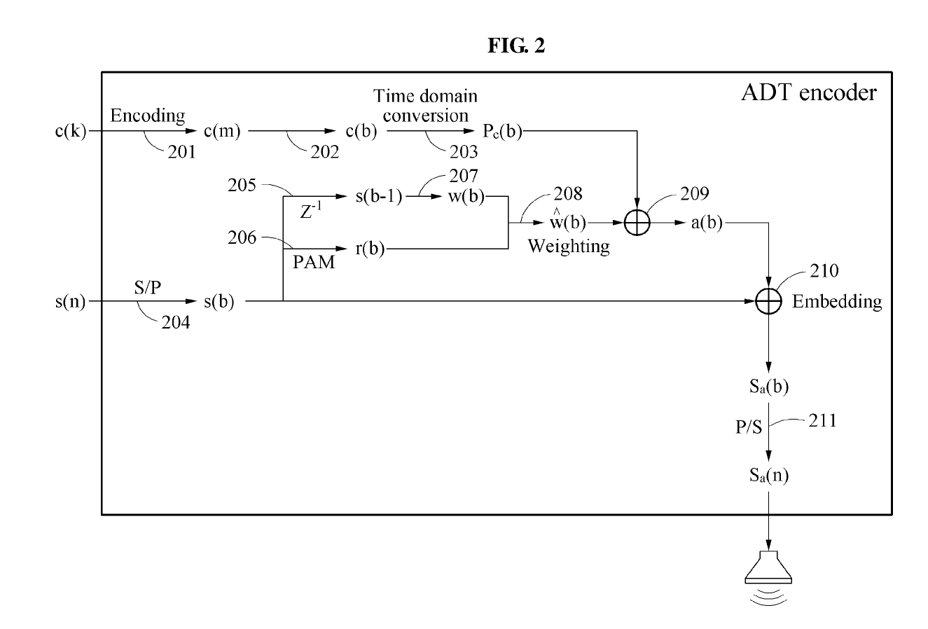

FIG. 2 is a diagram illustrating a process of embedding data in an audio signal in an ADT encoder according to an example embodiment.

Referring to FIG. 2, in stage 201, data to be embedded, for example, original data c(k), may be encoded to a bitstream c(m) having a bit index m. Here, 0≦k≦L−1 and 0<m≦M−1, wherein L denotes a bit number of the original data c(k), and M denotes an actual bit number of bits to be transmitted after the encoding. The encoding used herein may refer to channel encoding. Such an encoding process may be required for error detection and correction in the same manner as used in wireless communications. After the encoding, in stage 202, the bitstream c(m) may be matched to a frame index b, and c(b) denotes a result of the matching. c(b) that indicates 1 bit, or a single bit, per frame may be finally embedded in a host audio signal s(n). Here, b denotes a frame index, and n denotes a time sample index. The embedding used herein may also be referred to as inserting or insertion.

In stage 204, the host audio signal s(n) may need to be packed to be in a form of a vector to be converted to a frame signal. That is, the host audio signal s(n) in a series form may be converted to a signal in a parallel form, and thus may become a host audio signal in a frame form. S(b) obtained through the conversion may be represented by Equation 1 below, wherein N denotes a frame size.

s(b)=[s(n−b·N+1), . . . , s(n−(b−1)·N)]^{T} [Equation 1]

In stage 203, c(b) may be converted to a random time sequence P_{c}(b). Subsequently, c(b) may be inserted into each frame of an input signal, for example, the host audio signal s(b) obtained through the conversion to the parallel form. Here, p_{c}(i)∈ {−1,1}, and c denotes zero or 1 and may be identical to a value of c(b), which indicates that the random time sequence P_{c}(b) may need to be two types. A set of the random time sequence P_{c}(b) may need to be selected based on a value of a peak-to-average power ratio (PAPR) when a cross-correlation between the two types of random time sequences. For example, a length of the random time sequence P_{c}(b) may be 2048, which is identical to a frame size, and a PAPR of the random time sequence P_{c}(b) may be 25 decibels (dB) with an approximate length of 2048.

Such an embedding process may include three stages including a stage (e.g., stages 205 and 207) of generating a carrier signal, a stage (e.g., stages 206 and 208) of weighting or perceptually weighting a spectral coefficient of a host audio signal, and a stage (e.g., stages 209 and 210) of embedding data.

In the stage of generating a carrier signal, a carrier signal in a form of a vector may be defined by Equation 2 below. In Equation 2, \textcircled{×} denotes an element-wise multiplication.

w(b)={s(b−1)+n(b)}\textcircled{×}win(b) [Equation 2]

In stage 205, the frame-form host audio signal s(b) may become s(b−1) by being delayed by one frame. In stage 207, the vector-form carrier signal w(b) may be generated by applying or multiplying a window win(b) to or with a sum of the one frame delayed frame-form host audio signal s(b−1) and a frame-form noisy signal n(b).

A bit error rate (BER) may be determined by a degree of carrier power. Thus, in Equation 2, the noise signal term n(b) may be used when power of the one frame delayed frame-form host audio signal s(b−1) is extremely low or close to zero. For example, Gaussian noise having a unit variance may be used as an offset term of an additional carrier signal. In Equation 2, the delayed signal term s(b−1) may function as perceptual masked noise with respect to a current frame-form host audio signal.

The window win(b) in Equation 2 may be an analysis window having an element win(n), and be defined by Equation 3 below.

$$win ( b ) = \{ \begin{matrix}sin ( \frac{π}{L π} ( n + 0.5 ) ) & 0 \leq n \leq \frac{L}{2} \\ 1 & \frac{L}{2} \leq n \leq \frac{L}{2} + M \\ sin ( \frac{π}{L π} ( n + 0.5 ) ) & \frac{L}{2} + M \leq n \leq N\end{matrix} \qquad [ Equation 3 ]$$

In Equation 3, L denotes an overlapping portion in concatenating frames, and M denotes a flat portion in the middle of a window win(b). For example, the overlapping portion may be adjusted in proportion to a frame size N, from 50% to 6.25%. When the overlapping portion among the frames is larger, a severer intersymbol interference (ISI) may occur and a BER may increase, while a distortion by a block artifact may be reduced. In contrast, when the overlapping portion is smaller, an ISI may be reduced, while a distortion by a block artifact may increase and a sound quality may be degraded when a host audio signal changes after data is embedded in the host audio signal or rapidly changes among host audio signal frames.

In stage 208, a weighted vector-form carrier signal ŵ(b) may be obtained through a spectral weighting process as represented by Equation 4 below.

ŵ(b)=IDFT {γ(b)\textcircled{×}DFT {w(b)}} [Equation 4]

In Equation 4, a DFT{ } operator denotes discrete Fourier transform (DFT) of an input vector. That is, the DFT{ } operator may convert a time-domain input vector to a frequency-domain vector. In stage 260, a weighting vector γ(b) may be calculated from a perceptual audio model (PAM) in association with a masking-to-noise ratio (MNR).

The weighting process in Equation 3 may prevent a third user from hearing or perceiving the data embedded in the host audio signal. The weighting vector γ(b) may be multiplied by the vector-form carrier signal w(b) obtained through the conversion to the frequency-domain vector. That is, the weighting vector γ(b) may weight a spectral coefficient of the vector-form carrier signal w(b) obtained from the host audio signal. Here, the weighting may also be referred to as perceptual weighting. A result of the perceptual weighting may be transformed by an inverse DFT{ } (IDFT{ }) operator. The IDFT{ } operator may convert the result of the perceptual weighting to a time domain. As a result, the weighted vector-form carrier signal ŵ(b) may be obtained.

In stage 209, which is the last stage of embedding data, a vector-form signal a(b) to be embedded may be calculated by combining, with a band-pass filter h(b), a result of multiplication of the random time sequence P_{c}(b) and an absolute value of the weighted vector-form carrier signal ŵ(b).

a(b)=h(b)*{|ŵ(b)|\textcircled{×}p_{c}(b)} [Equation 5]

In Equation 5, the band-pass filter h(b) may restrict a frequency band of a signal embedded with the vector-form signal a(b) to minimize perceptual degradation, after embedding the vector-form signal a(b) in the frame-form host audio signal s(b), as represented by Equation 6 below. The vector-form signal a(b) to be embedded may include data to be embedded. The the vector-form signal a(b) to be embedded may be a final version of masked noise that is obtained by scaling an amplitude of the vector-form signal a(b) with the weighting vector γ(b) and performing band-pass filtering on the weighted vector-form carrier signal γ(b) using the band-pass filter h(b).

sₐ(b)={s(b)+a(b)}\textcircled{×}win(b) [Equation 6]

In stage 210, after embedding the vector-form signal a(b) in the frame-form host audio signal s(b), the multiplication of the window win(b) may be performed. As a result of the multiplication, sₐ(b) may be obtained. Here, the window win(b), which is a square of a sine window, may be completely eliminated during an overlap-add concatenation process, and thus the multiplication may be possible.

In stage 211, sₐ(b) may be sampled. During the sampling, sₐ(b) in a parallel form may be converted to a series form. As a result, sₐ(n) may be obtained. The sampled sₐ(n) may be externally transmitted through a speaker.

ADT encoding may be used to prevent a third user from hearing or perceiving embedded data. Thus, filtering the frequency band using the band-pass filter h(b) having a narrow pass-band and scaling down the amplitude with the weighting vector γ(b) may be performed concurrently. Further, the ADT encoding may be used to allow a signal embedded with data to overcome an audio channel distortion and to have a lower BER. Thus, filtering the frequency band using the band-pass filter h(b) having a broad pass-band and scaling up the amplitude with the weighting vector γ(b) may need to be performed concurrently. Such requirements described above may collide with each other, and thus careful consideration on requirements for a target application may need to be made when selecting configurations of the weighting vector γ(b) and the band-pass filter h(b). For example, an indoor application may require maintenance of an audio quality with a low data transmission rate. In contrast, an outdoor application may require overcoming of a severe channel distortion with a low sensitivity to an audio quality.

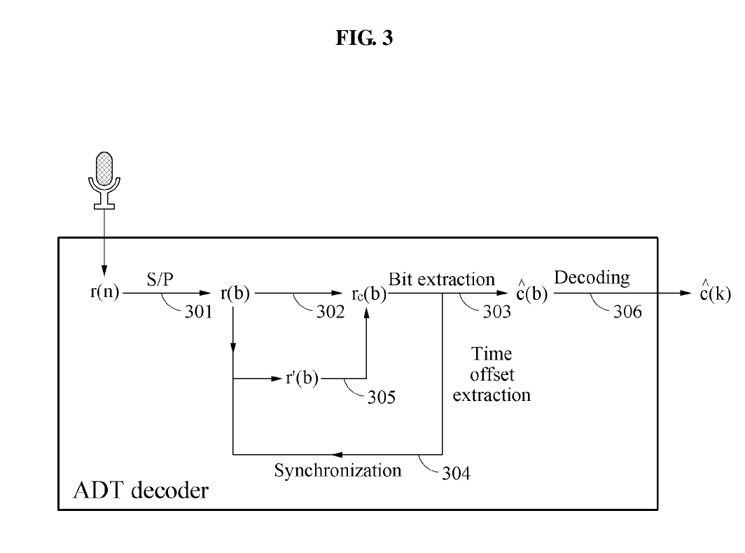

FIG. 3 is a diagram illustrating a process of extracting data from an audio signal in an ADT decoder according to an example embodiment.

Referring to FIG. 3, a signal r(n) may be received by a microphone. The received signal r(n) may be a time-domain audio signal in which data is embedded. In stage 301, the received signal r(n) may be converted to a frame-form signal r(b). The received signal r(n) may be in a serial form, and the frame-form signal r(b) may be in a parallel form.

In stage 302, r_{c}(b) including information associated with a correlation between a codeword and the signal r(b) may be obtained from the signal r(b). In stage 302, r_{c}(b), which is a normalized cross-correlation value of the signal r(b), may be obtained. Dissimilar to audio watermarking, the normalization of the cross-correlation may be required during ADT decoding due to a propagation distortion, such as, for example, an unstable dynamic range of a recording device and unpredicted non-stationary noise. r_{c}(b) may be calculated as represented by Equation 7 below.

$${r}_{c} ( b ) = \frac{real ( {r}^{f} ( b ) {( {d}_{c}^{f} ( b ) )}^{H} )}{\sqrt{{r}^{f} ( b ) {( {r}^{f} ( b ) )}^{H} {d}_{c}^{f} ( b ) {( {d}_{c}^{f} ( b ) )}^{H}}} \qquad [ Equation 7 ]$$

In Equation 7, H denotes a Hermitian operator to be obtained through complex conjugate and transposing, and an operator real( ) may be an operator configured to derive a real value from a complex value. An operator f denotes a DFT vector after transformation. r_{c}(b) in Equation 7 may be construed as being a cosine value to be obtained by deriving an inner product of two complex vectors with normalized terms. Thus, when the two complex vectors are orthogonal to each other, r_{c}(b) may be zero. When the two complex vectors are highly cross-correlated, r_{c}(b) may be close to 1.

A vector d_{c}(b) of Equation 7 may be derived from Equation 8 below.

d_{c}(b)=h(b)*p_{c}(b) [Equation 8]

In stage 304, a time sequence index or a time offset may be measured by a cross-correlation between the vector d_{c}(b) and the signal r(b). A position of a maximum absolute value may be a time shift lag, which is the time offset. That is, an offset value may be determined by selecting a codeword, and performing peak picking from a correlation function between the selected codeword and the signal r(b). A channel impulse response that changes based on a time may readily change an offset, and thus time synchronization may need to be continuously performed in each frame.

The time sequence index or the time offset, τ, may be applied to the signal r(b) by Equation 9 below. A range of the time offset τ may be −N/2 to N/2.

r′(b)=[r(n−N+1−τ), . . . , r(n−τ)]^{T} [Equation 9]

In stage 303, a bit may be extracted from r_{c}(b) to obtain a codeword ĉ(b). In detail, the codeword ĉ(b) may be simply determined by comparison associated with an absolute value of r_{c}(b) as represented by Equation 10 below.

$$\hat{c} ( b ) = {arg max}_{c} ( {r}_{c} ( b ) ) \qquad [ Equation 10 ]$$

In Equation 10, an arg max(f(x)) operator may obtain x that maximizes f. That is, the codeword ĉ(b) may obtain b that maximizes r_{c}(b). Subsequently, in stage 306, the codeword ĉ(b) may be decoded, and ĉ(k) may be obtained as a result of the decoding. When ĉ(k) matches the original data c(k) of FIG. 2, a disclosed method of embedding data in an audio signal based on a time domain and extracting the embedded data may become robust against a distortion.

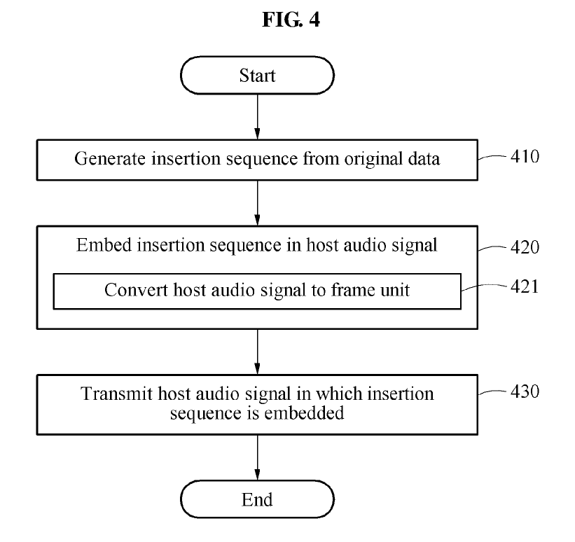

FIG. 4 is a flowchart illustrating a method of extracting data from an audio signal based on a time domain according to an example embodiment.

Referring to FIG. 4, in operation 410, an ADT encoder generates a time-domain insertion sequence from original data based on a weighting element. With reference to FIG. 2, the original data may be c(k), the weighting element may be the weighting vector γ(b), and the time-domain insertion sequence may be the vector-form signal a(b) to be embedded.

In operation 420, the ADT encoder embeds the insertion sequence in a host audio signal. In an example, in operation 421, the ADT encoder converts the host audio signal to a frame unit. With reference to FIG. 2, the host audio signal may correspond to s(n), and the host audio signal converted to the frame unit may correspond to s(b).

In operation 430, the ADT encoder transmits the host audio signal in which the insertion sequence is embedded. The ADT encoder may transmit an audio signal to an ADT decoder through a sound output device such as a speaker.

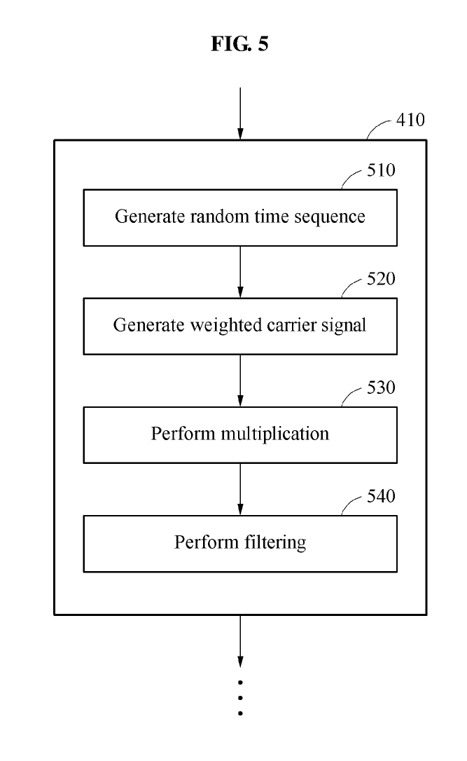

FIG. 5 is a flowchart illustrating a process of generating an insertion sequence from original data according to an example embodiment.

Referring to FIG. 5, in operation 510, an ADT encoder generates a random time sequence from original data. With reference to FIG. 2, the original data may be c(k), and the random time sequence may be P_{c}(b).

In operation 520, the ADT encoder generates a weighted time-domain carrier signal from a host audio signal. With reference to FIG. 2, the host audio signal may be s(n), and the weighted time-domain carrier signal may be ŵ(b).

In operation 530, the ADT encoder multiplies the random time sequence and the weighted time-domain carrier signal. With reference to FIG. 2, operation 530 may correspond to a portion of stage 209, and the random time sequence may be P_{c}(b) and the weighted time-domain carrier signal may be ŵ(b). In detail, the ADT encoder may multiply P_{c}(b) and an absolute value of ŵ(b) based on Equation 5 above.

In operation 540, the ADT encoder filters the multiplied carrier signal. With reference to FIG. 2, operation 540 may correspond to a portion of stage 209, and the multiplied carrier signal may be the result of the multiplication of P_{c}(b) and the absolute value of ŵ(b) based on Equation 5 above. For example, the filtering may be performed on the multiplied carrier signal using the band-pass filter h(b). Thus, as represented by Equation 6, the vector-form signal a(b) may be embedded in the host audio signal s(b), and thus perceptual degradation may be minimized.

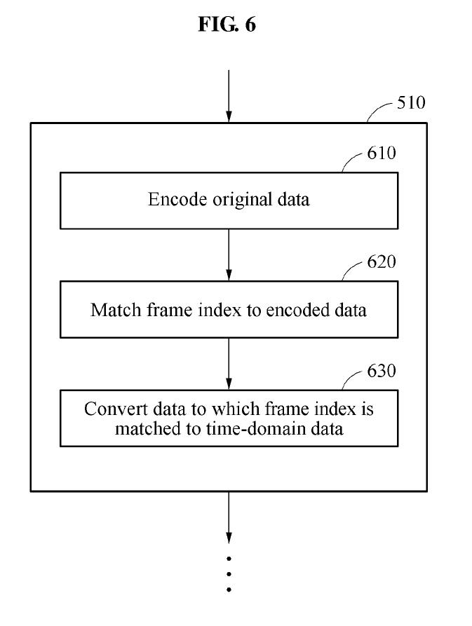

FIG. 6 is a flowchart illustrating a process of generating a random time sequence according to an example embodiment.

Referring to FIG. 6, in operation 610, an ADT encoder encodes original data. With reference to FIG. 2, operation 610 may correspond to stage 201, and the original data may correspond to c(k) and a result of the encoding may correspond to c(m). Such an encoding process may be required for error detection and correction in the same manner as in wireless communications.

In operation 620, the ADT encoder matches a frame index to the encoded data. With reference to FIG. 2, operation 620 may correspond to stage 202, and the encoded data may correspond to c(m), and a result of the matching may correspond to c(b). Here, operation 620 may be to connect each bit of a bitstream to a frame in order to process data by a frame unit.

In operation 630, the ADT encoder generates a random time sequence by converting the data to which the frame index is matched to time-domain data. With reference to FIG. 2, operation 630 may correspond to stage 230 of FIG. 2, and the data to which the frame index may correspond to c(b) and the random time sequence may correspond to P_{c}(b). The original data c(k) may be converted to a time-domain sequence. The ADT encoder may perform data insertion in a time domain.

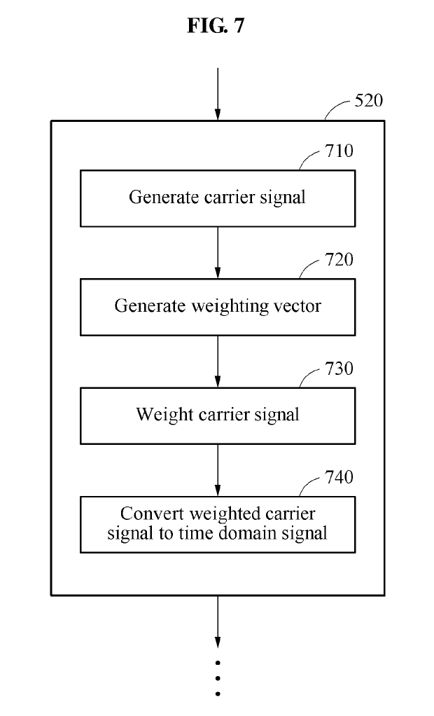

FIG. 7 is a flowchart illustrating a process of generating a weighted carrier signal according to an example embodiment.

Referring to FIG. 7, in operation 710, an ADT encoder generates a carrier signal by combining a host audio signal and a noisy signal. With reference to FIG. 2, operation 710 may correspond to stages 205 and 207 of FIG. 2, and the host audio signal may correspond to s(b) and the noisy signal may correspond to n(b) of Equation 2. The noisy signal term n(b) may be used when power of a delayed frame-form host audio signal is extremely low or is close to zero. The host audio signal may be delayed by a frame unit before being combined with the noisy signal. For example, the host audio signal may correspond to s(b−1) that is delayed by one frame. The delayed signal term s(b−1) may function as perceptual masked noise with respect to a current frame-form host audio signal. In an example, the ADT encoder may combine the host audio signal and the noisy signal, and multiply a window and a result obtained by the combining.

In operation 720, the ADT encoder generates a weighting vector from the host audio signal. With reference to FIG. 2, operation 720 may correspond to stage 206 of FIG. 2, and the weighting vector may correspond to γ(b). The weighting vector γ(b) may be calculated from a PAM in association with an MNR.

In operation 730, the ADT encoder weights the carrier signal based on the weighting vector. With reference to FIG. 2, operation 730 may correspond to a portion of stage 208 of FIG. 2.

In operation 740, the ADT encoder converts the weighted carrier signal to a time-domain signal. With reference to FIG. 2, operation 740 may correspond to a portion of stage 208 of FIG. 2. That is, operation 740 may correspond to the IDFT{ } operator of Equation 4. Thus, the ADT encoder may multiply the random time sequence and the weighted carrier signal in the time domain.

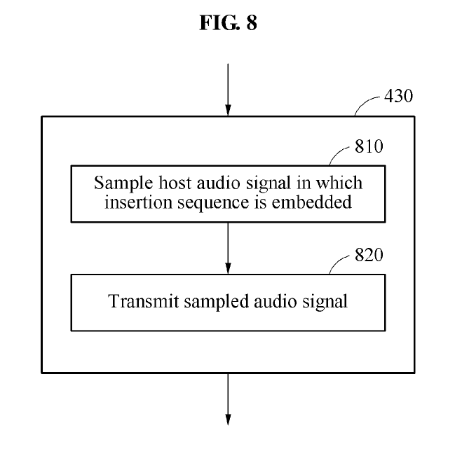

FIG. 8 is a flowchart illustrating a process of transmitting a host audio signal in which an insertion sequence is embedded according to an example embodiment.

Referring to FIG. 8, in operation 810, an ADT encoder samples a host audio signal in which an insertion sequence is embedded. With reference to FIG. 8, operation 810 may correspond to stage 211 of FIG. 2, and the host audio signal embedded with the insertion sequence may correspond to sₐ(b), and a result of the sampling may correspond to sₐ(n). The host audio signal embedded with the insertion sequence may be in a parallel form, and the result of the sampling may be in a serial form.

In operation 820, the ADT encoder transmits the sampled audio signal. For example, the ADT encoder may transmit the sampled audio signal to an ADT decoder through a speaker.

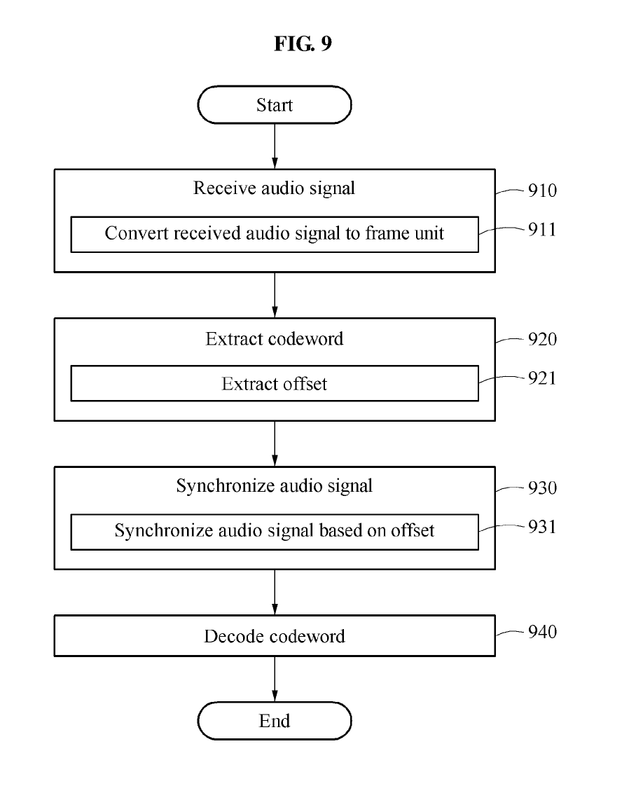

FIG. 9 is a flowchart illustrating a method of extracting data from an audio signal based on a time domain according to an example embodiment.

Referring to FIG. 9, in operation 910, an ADT decoder receives a time-domain audio signal in which data is embedded. In an example, in operation 911, the ADT decoder converts the received audio signal to a frame unit. With reference to FIG. 3, operation 911 may correspond to stage 301 of FIG. 3, and the time-domain audio signal in which the data is embedded may correspond to r(n) and a result of the conversion to the frame unit may correspond to r(b). That is, the received audio signal may be converted to a frame form.

In operation 920, the ADT decoder extracts a codeword from the audio signal. In an example, in operation 921, the ADT decoder extracts a time offset. With reference to FIG. 3, operation 920 may correspond to stage 303 of FIG. 3 and operation 921 may correspond to stage 304 of FIG. 3, and the audio signal may correspond to r(b). A time sequence index or the time offset may be measured by a cross-correlation between d_{c}(b) and r(b) of Equation 8. That is, the time offset may be determined by selecting the codeword, and performing peak picking from a correlation function between the selected codeword and r(b).

In operation 930, the ADT decoder synchronizes the audio signal based on the codeword. In an example, in operation 931, the ADT decoder performs the synchronization based on the time offset. With reference to FIG. 3, operations 930 and 931 may correspond to stage 304 of FIG. 3, and the time offset may correspond to τ of Equation 9. The ADT decoder may perform the synchronization by shifting the audio signal r(b) by the time offset τ to be r′(b). A channel impulse response that changes based on a time may readily change an offset, and thus the time synchronization may need to be continuously performed in each frame.

In operation 940, the ADT decoder decodes the codeword. With reference to FIG. 3, operation 940 may correspond to stage 306 of FIG. 3, and a result of the decoding may correspond to ĉ(k). When ĉ(k) corresponds to the original data c(k) of FIG. 2, the disclosed method of embedding data in an audio signal based on a time domain and extracting the data may become more robust against a distortion. Here, the decoding method may correspond to the encoding method described above.

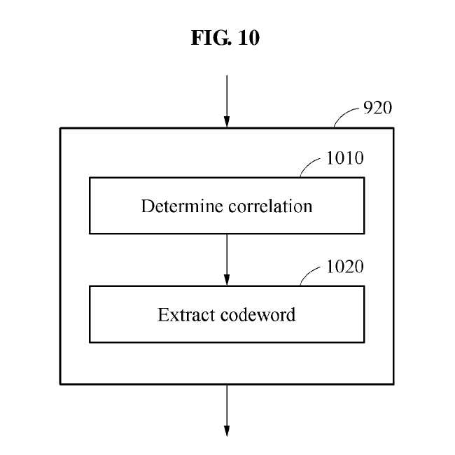

FIG. 10 is a flowchart illustrating a process of extracting a codeword according to an example embodiment.

Referring to FIG. 10, in operation 1010, an ADT decoder determines a correlation between an audio signal and a random time sequence. With reference to FIG. 3, operation 1010 may correspond to stage 302 of FIG. 3, and the audio signal may correspond to r(b) and the correlation may correspond to r_{c}(b). Here, r_{c}(b) may be a normalized cross-correlation value. Through normalization, the ADT decoder may reduce a propagation distortion, such as, for example, an unstable dynamic range of a recording device and unpredicted non-stationary noise.

The audio signal in which data is embedded may be associated with the random time sequence. That is, the audio signal embedded with the data may be a signal that is generated based on the random time sequence in an ADT encoder.

In operation 1020, the ADT decoder extracts a codeword from the correlation. With reference to FIG. 3, operation 1020 may correspond to stage 303 of FIG. 3, and the correlation may correspond to r_{c}(b) and the codeword may correspond to ĉ(b). In detail, ĉ(b) may be used to obtain b that maximizes r_{c}(b) as represented by Equation 10, and b may correspond to the codeword ĉ(b).

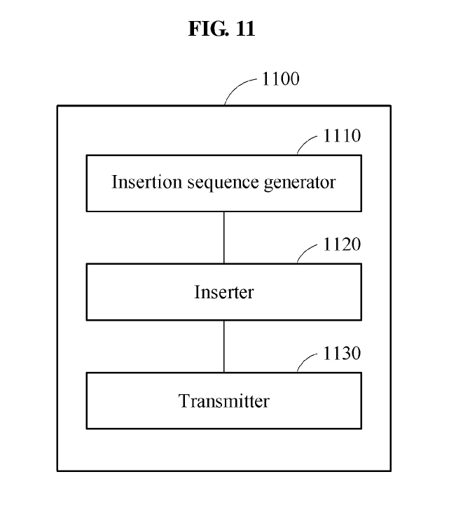

FIG. 11 is a diagram illustrating an ADT encoder 1100 according to an example embodiment.

The ADT encoder 1100 may be a device for embedding data in an audio signal based on a time domain. Referring to FIG. 11, the ADT encoder 1100 includes an insertion sequence generator 1110, an inserter 1120, and a transmitter 1130. The insertion sequence generator 1110 may generate a time-domain insertion sequence from original data based on a weighting element. The inserter 1120 may embed the insertion sequence in a host audio signal. The transmitter 1130 may transmit the host audio signal in which the insertion sequence is embedded.

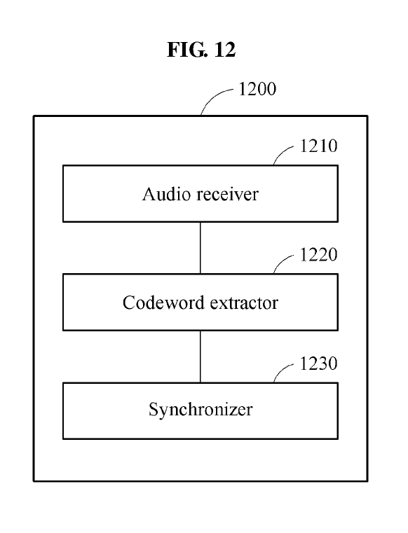

FIG. 12 is a diagram illustrating an ADT decoder 1200 according to an example embodiment.

The ADT decoder 1200 may be a device for extracting data from an audio signal based on a time domain. Referring to FIG. 12, the ADT decoder 1200 includes an audio receiver 1210, a codeword extractor 1220, and a synchronizer 1230. The audio receiver 1210 may receive a time-domain audio signal in which data is embedded. The codeword extractor 1220 may extract a codeword from the received audio signal. The synchronizer 1230 may synchronize the audio signal based on the extracted codeword.

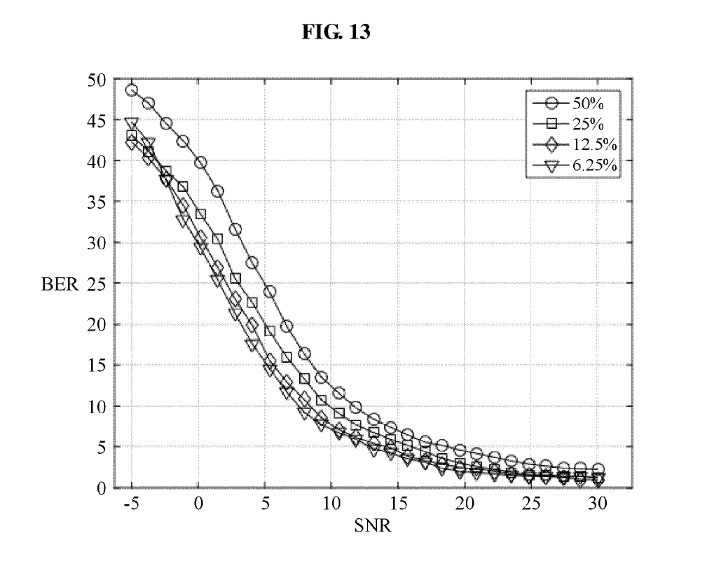

FIGS. 13, 14, and 15 are graphs illustrating simulation results. For simulations, three speech items and three music items were alternately used as a host audio signal. In the simulations, a sampling rate was set to be 48 kilohertz (kHz), and a resolution was set to be 16 bits. The simulations were conducted to observe a BER performance without a correction, and a channel coding architecture may not need to be applied to all the following simulations.

FIG. 13 is a graph illustrating an average BER with respect to different window overlap sizes according to an example embodiment.

A simulation was conducted by adding Gaussian white noise and increasing a signal-to-noise ratio (SNR) to 30 dB from −5 dB, in order to observe a performance change based on a change in size of an overlap among transmission frames. When an overlap size is larger, a greater ISI may occur among the frames. However, when a frame size is fixed and a distortion by a block artifact between frames to be transmitted is minimized, a data rate may increase.

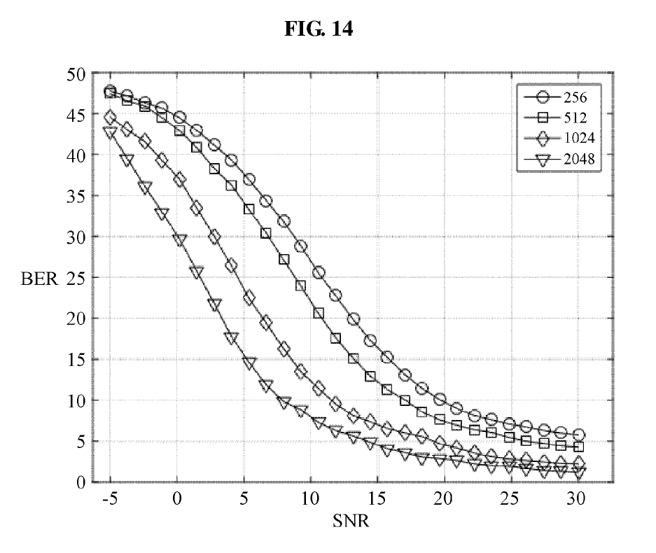

FIG. 14 is a graph illustrating an average BER with respect to different frame sizes according to an example embodiment.

FIG. 14 illustrates an average BER depending on a ratio of an overlap size to an input SNR. In response to an increase in an ISI, the BER may increase, which may be a rational result. In terms of BER efficiency, overlap-free transmission may be useful to minimize an ISI. However, a quality of a host audio signal may be perceptually degraded by a distortion due to different modulations among concatenated frames. A recommendable ratio of an overlap size may be at least 12.5%, which may be used to minimize an audible quantization distortion in audio coding. For example, 256 point overlap may be heard with respect to a frame size of 2048. Thus, in the simulation, the 12.5% overlap size may be applied to data to be embedded to perceptually hide a distortion due to discontinuance among transmission frames. In terms of an input SNR, a main target for the simulation may be an indoor environment, and a predicted SNR value may start from −5 dB. In an outdoor environment, a severer SNR may be predicted. In addition, all parameters used in an ADT system suggested herein, for example, a perceptual weighting element, a transmission overlap and frame size, and a data rate associated with a response time of a receiver, may be modified. A result of the simulation illustrated in FIG. 14 may indicate that the average BER may depend on an increase in a transmission frame size with a 12.5% overlap windowing. Here, when the frame size is smaller, a greater data rate and a decreased PAPR of an embedded code P_{c}(b) may be observed, which may result in a lower BER. In the indoor environment, the BER may be sufficiently supported while data acquisition with the 2048 frame size is preferable to support data transmission from 5 dB to 10 dB with a reliable BER below 10%. In such a case, when a host audio signal has a 48 kHz sampling rate, a data rate may be 31.25 bits per second (bps).

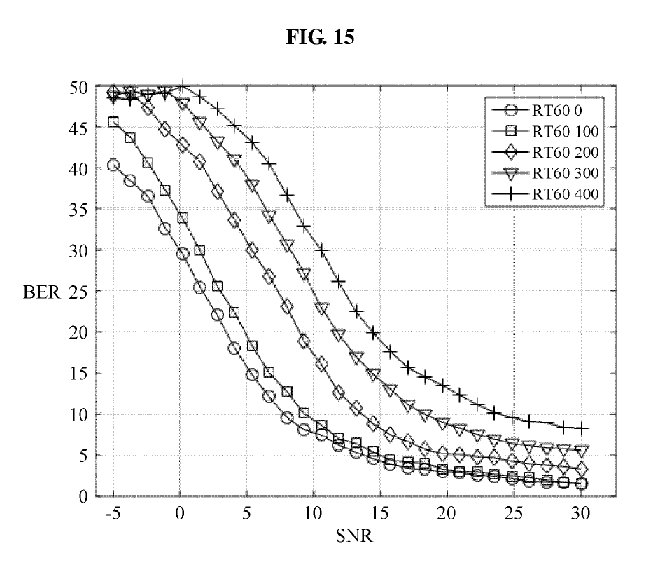

FIG. 15 is a graph illustrating an average BER with respect to different reverberation times according to an example embodiment.

A simulation was conducted in relation to reverberation. The reverberation may occur mainly indoors. An indoor environment of the simulation was a 6 meters (m)×4 m×2.4 m-sized room with a synthesized indoor impulse response based on an image method. The indoor impulse response was measured at a reverberation time (RT) 60 with respect to 100, 200, 300, and 400 milliseconds (ms). RT60 may be a time required for reflections of a direct sound to decay 60 dB. The RT60 is a basic parameter of indoor sound reverberation. A microphone was located at a height of 1.2 m in the middle of the room, and a speaker was located at the same height as the microphone and located 1.5 m away from where the microphone is located. To include an effect of the reverberation, a result of a desirable channel, for example, an indoor impulse response with RT60 being 0, was not observed. To consider an effect of the reverberation, a result of a desirable channel such as RT 60 0, in an absence of a room impulse response, was observed. To maintain a BER to be less than or equal to 10%, an approximately 15 dB input SNR may be required for 100 and 200 ms. However, at least 20 dB SNR may need to be ensured for 300, 400, and 500 ms.

According to example embodiments, by generating a time-domain insertion sequence from original data based on a weighting element, embedded data may not be heard by or revealed to a third user.

According to example embodiments, by filtering a result obtained from multiplication of a random time sequence and a weighted time-domain carrier signal, embedded data may become more robust against a distortion of an audio channel.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

Accordingly, while example embodiments of the inventive concepts are capable of various modifications and alternative forms, embodiments thereof are shown by way of example in the drawings and will herein be described in detail. It should be understood, however, that there is no intent to limit example embodiments of the inventive concepts to the particular forms disclosed, but to the contrary, example embodiments of the inventive concepts are to cover all modifications, equivalents, and alternatives falling within the scope of example embodiments of the inventive concepts.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments of the inventive concepts. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

What is claimed is:

1. A method of embedding data in an audio signal, the method comprising:
generating a time-domain insertion sequence from original data based on a weighting element;
embedding the insertion sequence in a host audio signal; and
transmitting the host audio signal in which the insertion sequence is embedded.

2. The method of claim 1, wherein the generating of the insertion sequence comprises:
generating a random time sequence from the original data;
generating a weighted time-domain carrier signal from the host audio signal; and
multiplying the generated random time sequence and the generated weighted time-domain carrier signal.

3. The method of claim 2, wherein the generating of the insertion sequence further comprises:
filtering the multiplied carrier signal.

4. The method of claim 2, wherein the generating of the random time sequence comprises:
encoding the original data;
matching a frame index to the encoded data; and
converting the data to which the frame index is matched to time-domain data, and generating the random time sequence.

5. The method of claim 2, wherein the generating of the weighted carrier signal comprises:
generating a carrier signal by combining the host audio signal and a noisy signal;
generating a weighting vector from the host audio signal; and
weighting the carrier signal based on the weighting vector.

6. The method of claim 5, wherein the generating of the weighted carrier signal further comprises:
converting the weighted carrier signal to a time-domain signal.

7. The method of claim 5, wherein the generating of the carrier signal by combining the host audio signal and the noisy signal comprises:
multiplying a window and a result obtained by combining the host audio signal and the noisy signal.

8. The method of claim 1, wherein the embedding comprises:
converting the host audio signal to a frame unit.

9. The method of claim 1, wherein the transmitting comprises:
sampling the host audio signal in which the insertion sequence is embedded; and
transmitting the sampled audio signal.

10. A method of extracting data from an audio signal, the method comprising:
receiving a time-domain audio signal in which data is embedded;
extracting a codeword from the received audio signal; and
synchronizing the audio signal based on the extracted codeword.

11. The method of claim 10, wherein the receiving comprises:
converting the received audio signal to a frame unit.

12. The method of claim 10, wherein the extracting of the codeword comprises:
determining a correlation between the audio signal and a random time sequence; and
extracting the codeword from the correlation,
wherein the audio signal in which the data is embedded is associated with the random time sequence.

13. The method of claim 10, wherein the extracting of the codeword comprises:
extracting an offset from the correlation between the audio signal and the random time sequence, and
the synchronizing comprises:
synchronizing the audio signal based on the extracted offset.

14. The method of claim 10, further comprising:
decoding the codeword.

15. An apparatus for embedding data in an audio signal, the apparatus comprising:
an insertion sequence generator configured to generate a time-domain insertion sequence from original data based on a weighting element;
an inserter configured to embed the insertion sequence in a host audio signal; and
a transmitter configured to transmit the host audio signal in which the insertion sequence is embedded.
